(19) United States
(12) Patent Application Publication
(10) Pub. No.: US 2026/0154940 A1
(43) Pub. Date: Jun. 4, 2026

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Hisayoshi Furihata, Tokyo (JP)

(21) Appl. No.: 19/459,590

(22) Filed: Jan. 26, 2026

Related U.S. Application Data
(63) Continuation of application No. 17/677,809, filed on Feb. 22, 2022.

(30) Foreign Application Priority Data
Feb. 25, 2021 (JP) 2021-028714
Jan. 27, 2022 (JP) 2022-011323

(51) Int. Cl. G06V 10/75; G06T 7/55; G06T 7/593; G06V 10/771

(52) U.S. Cl. CPC G06V 10/757; G06T 7/55; G06T 7/593; G06V 10/76; G06V 10/771; G06V 2201/07

(57) ABSTRACT

An information processing apparatus acquires a stereo image, performs matching of feature points of a first number smaller than the number of pixels in a first image to estimate three-dimensional positions of the feature points with respect to a stereo camera, sets the feature point determined to be acquired from a space set in a field of view of an imaging unit as a target point, sets surrounding points of a second number greater than the number of the feature points for which the three-dimensional positions are estimated in an image area within a predetermined distance range from the target point in the first image, and determines whether the target point is the feature point indicating a feature of an object existing in the space based on differences between the three-dimensional positions of the surrounding points and the target point with respect to the stereo camera.

### CROSS-REFERENCE TO RELATED APPLICATIONS

This application is a Continuation of U.S. patent application Ser. No. 17/677,809, filed Feb. 22, 2022, which claims the benefit of Japanese Patent Application No. 2021-028714, filed Feb. 25, 2021, and Japanese Patent Application No. 2022-011323, filed Jan. 27, 2022, all of which are hereby incorporated by reference herein in their entirety.

### BACKGROUND

### Field of the Disclosure

The present disclosure relates to a technique to acquire a feature of an object from a range image.

### Description of the Related Art

A technique is provided to calculate a range image based on stereo matching using an image captured by a stereo camera as an input to detect whether any object exists in front of the camera (N. B. Naveen Appiah, “Obstacle detection using stereo vision for self-driving cars”, IEEE Intelligent Vehicles Symposium, 2011).

This technique is used to detect an object (a person, an obstacle, or the like) existing around, for example, a robot or an automobile.

A range image acquired by the stereo matching may contain noise caused by failure of the matching. For example, a noise reduction filter, such as a median filter or a speckle filter, is used to determine and reduce the noise. In such a method of determining and reducing noise, a distance value that is a statistical minority is found with reference to multiple distance values in a local image area of the range image to remove the distance value that is found as the noise.

It is assumed that the original range image has dense distance values in each local image area in order to use the method of determining noise, which is based on the statistical calculation with reference to the multiple distance values. However, large processing load is applied to generate the dense range image based on the stereo matching and to determine noise from the dense range image.

### SUMMARY

In order to resolve the above issue, embodiments of the present disclosure are provided to accurately determine whether a feature point indicating a feature of an object is acquired from the three-dimensional space in the field of view of an imaging unit while suppressing the processing load.

An information processing apparatus according to an embodiment of the present disclosure includes an image acquisition unit, an estimation unit, a target point setting unit, a surrounding point setting unit, and a determination unit. The image acquisition unit acquires a first image from a first optical system and a second image from a second optical system. The first image and the second image are acquired from an imaging unit that includes the first optical system and the second optical system, which are arranged in a device so that an imaging field of view of the first optical system is at least partially overlapped with an imaging field of view of the second optical system. The estimation unit performs stereo matching of feature points of a first number that is smaller than a number of pixels in the first image in the first image and the second image to estimate three-dimensional positions of the feature points with respect to the imaging unit. The target point setting unit sets the feature point determined to be acquired from a three-dimensional space set in a field of view of the imaging unit based on the three-dimensional position, among the feature points of the first number, as a target point. The surrounding point setting unit sets surrounding points of a second number that is greater than the number of the feature points for which the three-dimensional positions are estimated by the estimation unit in an image area within a predetermined distance range from the target point in the first image. The determination unit determines whether the target point is the feature point indicating a feature of an object existing in the three-dimensional space based on differences between the three-dimensional positions of the surrounding points with respect to the imaging unit and the three-dimensional position of the target point with respect to the imaging unit. The three-dimensional positions are acquired through the stereo matching of the surrounding points using the first image and the second image.

Further features of the present disclosure will become apparent from the following description of exemplary embodiments with reference to the attached drawings.

### BRIEF DESCRIPTION OF THE DRAWINGS

FIG. 1 illustrates an example of an arrangement condition of a stereo camera and an object.

FIG. 2 illustrates an example of images captured by the stereo camera.

FIG. 3 illustrates an example of the functional configuration of an information processing apparatus.

FIG. 4 is a flowchart illustrating a flow of information processing.

FIG. 5 is a flowchart illustrating a flow of the information processing.

FIG. 6 is a flowchart illustrating a flow of the information processing.

FIG. 7 illustrates an example of the hardware configuration of the information processing apparatus.

FIG. 8 illustrates a modification of the stereo camera.

### DESCRIPTION OF THE EMBODIMENTS

### Embodiment

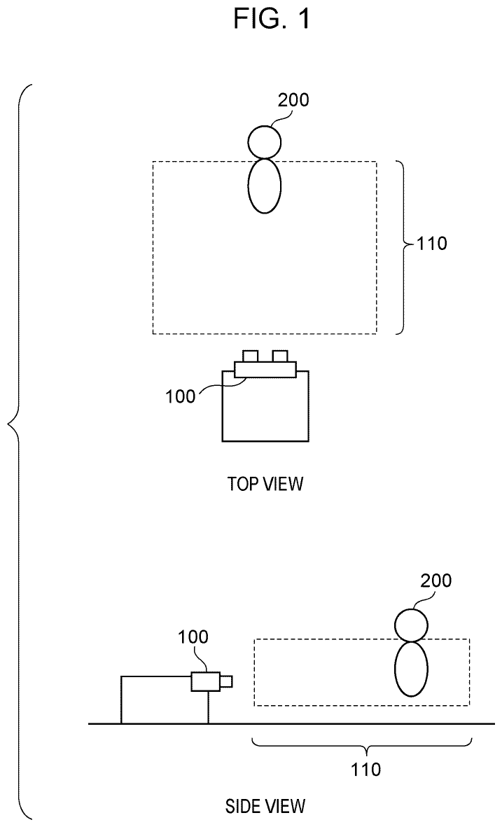

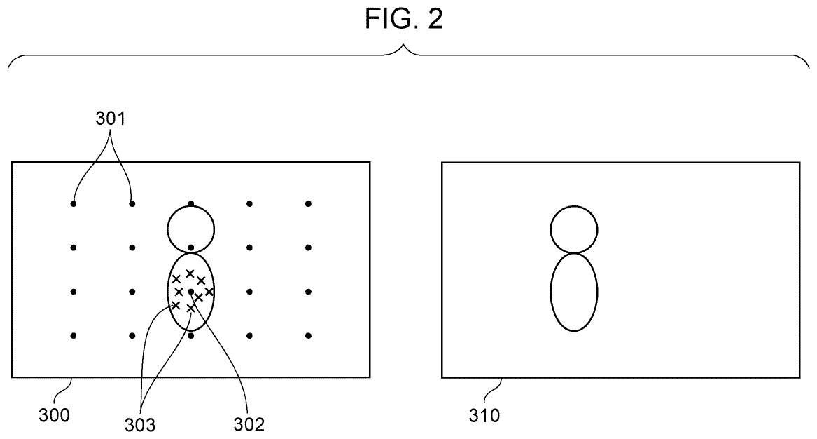

In an embodiment, a method of detecting whether any object exists in a forward field of view of a stereo camera (in a moving direction of a vehicle in which the stereo camera is placed) is considered. The stereo camera is mounted in, for example, an autonomous mobile robot (AMR), an automatic guided vehicle (AGV), or an autonomous mobile vehicle. The stereo camera can be mounted on a stationary device, such as a surveillance camera, as well as a moving device (vehicle). FIG. 1 illustrates an example of an arrangement condition of a stereo camera and an object in the present embodiment. Referring to FIG. 1, reference numeral 100 denotes a stereo camera, reference numeral 110 denotes a three-dimensional detection space in which the presence of an object is determined, and reference numeral 200 denotes an object. In the stereo camera 100, distance measurement is performed based on stereo matching of two images, such as images 300 and 310 illustrated in FIG. 2 (a first image captured by a first imaging apparatus (optical system) and a second image captured by a second imaging apparatus (optical system)). The presence of an object is determined based on whether a point calculated in the distance measurement is within the detection space 110. The measured distance is, for example, the distance from the imaging plane of a left-side camera in the stereo camera to a feature (a feature point on an image) of the object. The distance from the imaging plane of a right-side camera in the stereo camera to the feature of the object may be used or the distance from an intermediate point of certain positions of the respective cameras to the feature of the object may be used. The detection space 110 is set so that the lowest portion in the detection space 110 is higher than a moving plane in order not to use the feature point acquired from the image generated by capturing the moving plane in the following determination process. The height of the detection space 110 is set to, for example, a height calculated by using a certain coefficient from the height of the vehicle. The width and the depth of the detection space 110 are set to values at which avoidance of an obstacle is possibly difficult, for example, even if the steering wheel is turned or the brake is applied based on the moving speed of the vehicle.

A range image acquired by the stereo matching may contain noise caused by failure of the matching. In the present embodiment, the noise is data having values that are shifted from the actual distance values (true values) of the portions on the image, which are indicated by the respective pixels, in the distance values of the respective pixels on the range image. The noise reduction filter, such as the median filter or the speckle filter, is used to reduce noise. In such a method of reducing noise, the distance value that is greatly shifted from the average value (or the median) is found with reference to the distance values in the local image area of the range image to remove the distance value that is found as the noise. It is assumed that the original range image has multiple distance values in each local image area in order to perform the statistical calculation. Such a condition is hereinafter referred to as a dense range image. For example, the range image in which the distance values are estimated for all the pixels in a stereo image that is captured is the dense range image. In contrast, the range image that has a small number of pixels for which the distance values are estimated and that has thin distance values is referred to as a thin range image.

In the present embodiment, the stereo matching is performed only for points that are thinly set, as illustrated by reference numeral 301 in FIG. 2, to reduce calculation cost. The points that are set here are referred to as candidate points. Then, if any point that exists in the detection space 110 is included in the candidate points 301, the point that exists in the detection space 110 is set as a target point 302 to determine whether the target point 302 is noise. In the determination of noise, multiple points 303 within a certain range from the target point are set and the distance values of the multiple points are calculated based on the stereo matching. Then, it is determined whether the distance value of the target point is noise based on the distribution of the calculated distance values. If the distance value of the target point is not noise, it is determined that any object exists in the detection space 110. Since the stereo matching is performed using the candidate points 301 of a limited number and surrounding points set around the candidate points 301 in the determination of noise, it is possible to reduce the calculation cost for detection of an object, compared with a method of determining noise in the dense range image to detect an object.

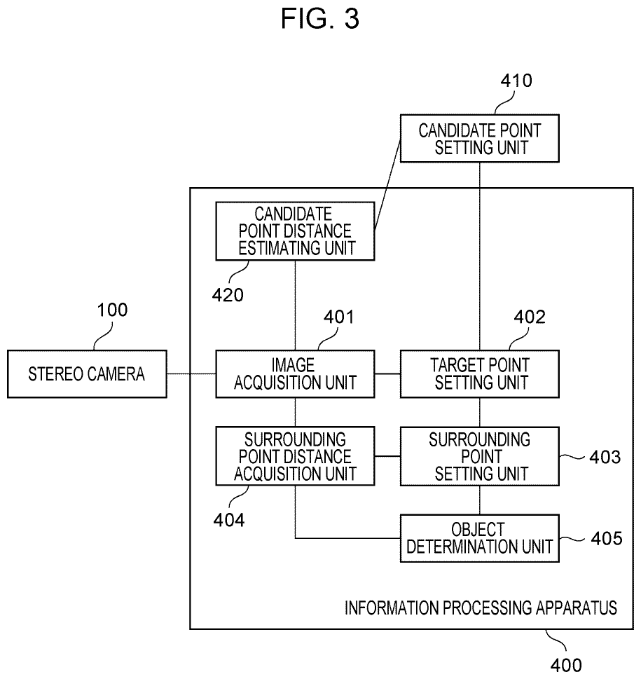

The present embodiment will now be described in detail. First, the module configuration of the present embodiment is described with reference to FIG. 3. Referring to FIG. 3, reference numeral 100 denotes the stereo camera, reference numeral 400 denotes an information processing apparatus, reference numeral 410 denotes a candidate point setting unit, and reference numeral 420 denotes a candidate point distance estimating unit. The information processing apparatus 400 includes an image acquisition unit 401, a target point setting unit 402, a surrounding point setting unit 403, a surrounding point distance acquisition unit 404, and an object determination unit 405. The information processing apparatus 400, the candidate point setting unit 410, and the candidate point distance estimating unit 420 each include a storage unit and a calculation unit, which are not illustrated in FIG. 3. The information processing apparatus 400 is realized by, for example, a general-purpose computer.

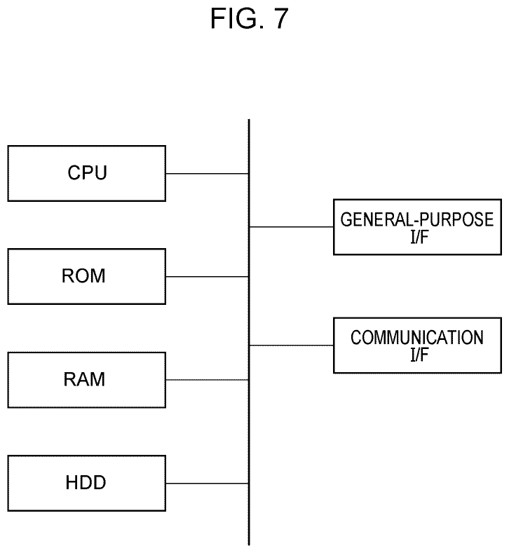

FIG. 7 illustrates the hardware configuration of the information processing apparatus 400. Referring to FIG. 7, the information processing apparatus 400 is composed of a central processing unit (CPU), a read only memory (ROM), a random access memory (RAM), a storage unit such as a hard disk drive (HDD) or a solid state drive (SSD), a general-purpose interface (I/F) such as a universal serial bus (USB), a communication I/F, and a system bus. The CPU executes an operating system (OS) and various computer programs, which are stored in the ROM, the storage unit, and so on, using the RAM as a working memory and controls each component via the system bus. For example, the programs executed by the CPU includes programs to perform processes described below.

The stereo camera 100 includes two cameras each capturing a two-dimensional image (the first imaging apparatus (optical system) and the second imaging apparatus (optical system)). It is assumed that camera parameters are known. The first imaging apparatus and the second imaging apparatus are arranged so that their imaging fields of view are at least partially overlapped with each other. The candidate point setting unit 410 sets the candidate points on the image captured by the stereo camera. The candidate point distance estimating unit 420 performs the stereo matching based on the two images captured by the stereo camera 100 (the first image captured by the first imaging apparatus and the second image captured by the second imaging apparatus) to calculate the distance values in the real space of the candidate points. The case is described in FIG. 3 in which the candidate point setting unit 410 is provided outside the information processing apparatus 400. The distance values of the candidate points may be acquired from output data from a range sensor (a range camera or the like), which is provided outside the information processing apparatus 400 separately from the stereo camera, and the acquired distance values may be input into the information processing apparatus. When the distance values of the candidate points are acquired from output data from a sensor provided in the information processing apparatus, the candidate point setting unit 410 may be provided in the information processing apparatus 400. The image acquisition unit 401 acquires the two images captured by the stereo camera 100. The target point setting unit 402 sets a point existing in the detection space 110 (the three-dimensional space), among the candidate points, as the target point. The surrounding point setting unit 403 sets multiple points around the target point. In an area set around the target point, the surrounding points are set so that the density of the surrounding points is higher than the density of the candidate points. The surrounding point distance acquisition unit 404 performs the stereo matching based on the two images captured by the stereo camera 100 to calculate the distance values of the surrounding points. The object determination unit 405 determines whether the target point is noise based on the distance values of the target point and the surrounding points to determine whether any object exists in the detection space 110 (the three-dimensional space) based on the result of the determination.

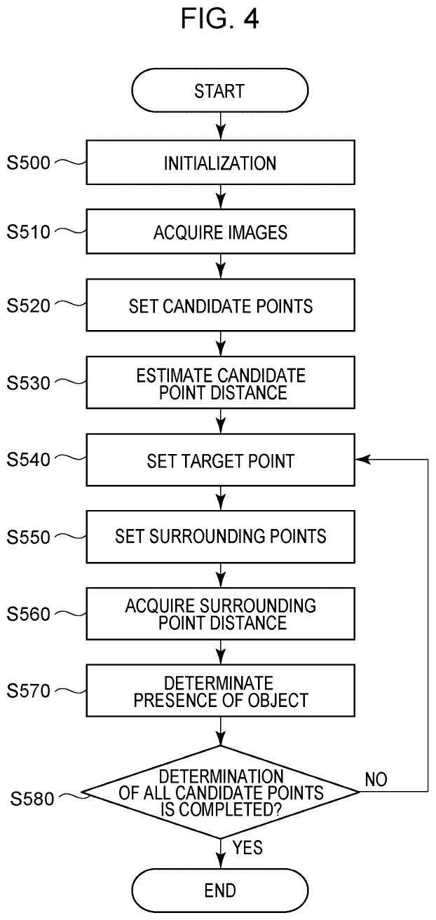

A specific process of the present embodiment will now be described. FIG. 4 is a flowchart illustrating the process. The flowchart is executed by the CPU that executes a control program. The process described with reference to FIG. 4 is started when the vehicle starts moving.

In Step S500, initialization for acquisition of an image and calculation is performed. Specifically, invocation of a program, start-up of the stereo camera, loading of parameters necessary for the process from the storage unit (not illustrated) included in the information processing apparatus 400, and so on are performed. Here, the parameters include the camera parameters of the stereo camera. The camera parameters are required for the stereo matching in the candidate point distance estimating unit 420 and the surrounding point distance acquisition unit 404.

In Step S510, the image acquisition unit 401 acquires two images captured by the stereo camera 100.

In Step S520, the candidate point setting unit 410 sets the candidate points on the image. In the present embodiment, the candidate points of an M number are set in a grid pattern at certain intervals on the image, as illustrated by the candidate points 301 in FIG. 2. The set candidate points are denoted by Ai (i=1 to M). M is a first number smaller than the number of pixels. This is equivalent to setting of the candidate points so that the density of the candidate points is decreased to be a density m.

In Step S530, the candidate point distance estimating unit 420 performs the stereo matching based on the two images captured by the stereo camera 100 to calculate the distance value of each candidate point Ai. In the present embodiment, the stereo matching is a process to perform block matching or the like on an epipolar line based on the camera parameters of the stereo camera. In the stereo matching, triangulation is performed based on the positions of the corresponding pixels to calculate the distance value. The three-dimensional position of each candidate point is also calculated. The distance value calculated for each candidate point is denoted by D(Ai).

In Step S540, the target point setting unit 402 sets the point existing in the detection space 110 (the three-dimensional space), among the candidate points, as the target point. The set target point is denoted by As and the distance value of the target point is denoted by D(As). Reference numeral 302 in FIG. 2 denotes examples of the target points As. The detection space 110 is a rectangular parallelepiped that is set so as to have a certain size in front of the stereo camera in the present embodiment. The front side of the stereo camera means the moving direction of the vehicle in which the stereo camera is placed. When the vehicle moves backward, the moving direction of the vehicle is the rear side of the vehicle.

In Step S550, the surrounding point setting unit 403 sets the multiple points 303 around the target point As. In the present embodiment, the surrounding point setting unit 403 selects points of an N number at random from the pixels existing in a distance range of a radius R around the target point As in the images acquired in Step S510 and sets the selected points as the surrounding points.

The set surrounding points are denoted by Bj (j=1 to N). (Setting of the points in the circular distance range of the radius R as the surrounding points is an example and the points in a partial area in the images are set as the surrounding points.) The density of the points in the distance range of the radius R around the target point As is set so as to be higher than the density m. The N number is a second number that is greater than the number of the candidate points existing in the distance range of the radius R around the target point As.

In Step S560, the surrounding point distance acquisition unit 404 performs the stereo matching based on the two images captured by the stereo camera 100 to calculate the distance value of each surrounding point Bj. The distance value calculated for the surrounding point is denoted by D(Bj).

In Step S570, the object determination unit 405 determines whether the target point is noise based on the distance values of the target point and the surrounding points to determine whether any object exists in the detection space 110 based on the result of the determination.

First, a ratio p of the number of the distance values D(Bj) similar to the distance value D(As) of the target point with respect to the number of the distance values D(Bj) of the respective surrounding points is calculated. Specifically, the ratio of the number of the surrounding points having the distance values within a predetermined range from the distance value D(As) of the target point with respect to the number N of the set surrounding points is calculated. The target point is determined to be noise if the ratio p is not higher than a threshold value T and the target point is determined not to be noise and to be the point of the pixel indicating the distance value of the object existing in the detection space 110 if the ratio p is higher than the threshold value T. In the latter case, it is determined that the object is detected. When the object is detected, measurement of the three-dimensional shape of the entire object is started to cause the vehicle to continue the movement while avoiding the object. Then, the vehicle is caused to continue the movement on a path avoiding the object. Alternatively, when the object is detected, the vehicle is stopped.

In Step S580, the steps from S540 to Step S570 are performed for all the candidate points while changing the target point.

It is determined in the above manner whether each candidate point set on the image is a point on the object included in the detection space 110. When only the “presence” of any obstacle is to be determined, the repetition of Steps from S540 to S570 is not necessary for the remaining candidate points at the time when the obstacle is detected for one candidate point in Step S570.

As described above, the stereo matching is performed not for all the pixels on the image but for the candidate points of a limited number and the surrounding points set around the candidate points. In the image area around the candidate points, the density of the surrounding points is higher than the density of the candidate points. This enables accurate detection of the presence of an object while reducing the calculation cost, compared with the method of generating the dense range image.

The candidate point setting unit 410 sets the candidate points on the image at equal intervals in Step S520. However, the calculation cost is capable of being reduced if a method of thinly setting at least one point on the image is used. The candidate points may be set on the image at equal intervals or at positions set at random. In shooting of a movie, the positions of the candidate points to be set may be varied with time. In this case, an occurrence of exclusion of detection in gaps having no candidate point is capable of being avoided by setting the candidate points at later times with the positions of the candidate points on the image being shifted so as to fill the gaps between the candidate points that are set at a certain time. The distance values of the candidate points may be calculated based on output data from a range sensor (a range camera or the like), which is provided separately from the stereo camera.

The surrounding point setting unit 403 sets the pixels at positions set at random around the target point in Step S550. However, in the setting of the surrounding points, the determination of whether the target point is noise is available if at least one surrounding point is set around the target point. The surrounding points may be set at positions set at random or may be set at positions that are equally spaced. The distribution of the positions of the surrounding points to be set desirably has no bias in the calculation of the distribution of the surrounding points in the object determination unit 405. The bias means, for example, use of only the right half of the area around the target point. If the distribution of the surrounding points to be set is biased, the amount of statistics depends on the biased portion and it may be difficult to accurately determine noise. Accordingly, in order to avoid the bias, the surrounding points are desirably set, for example, so that the surrounding points are spaced by a predetermined spacing or more at a probability that is equal to a certain value or that exceeds the certain value.

In addition, the surrounding point setting unit 403 calculates the ratio p of the surrounding points having the distance values similar to the distance value of the target point to determine whether the target point is noise. In the determination of whether the target point is noise, it is sufficient to evaluate the number of the surrounding points having the distance values similar to the distance value of the target point. The ratio p described above may be used or the number of the surrounding points having the distance values similar to the distance value of the target point may be used.

### First Modification

The number of the surrounding points set in the surrounding point setting unit 403 is the N number, which is a fixed number, in Step S550. In general, an error e estimated for the ratio p is varied depending on the number N of the surrounding points used in the calculation. Specifically, the error e is decreased as the number N is increased and the error e is increased as the number N is decreased.

In order to perform the accurate determination in the object determination unit 405, the error e is desirably not higher than the certain value. However, it takes a longer time to calculate the distance values in the surrounding point distance acquisition unit 404 as the number of the surrounding point to be set is increased to decrease the error e.

A method of decreasing the number of the surrounding points to be set while ensuring that the error e is not higher than the certain value in the surrounding point setting unit 403 will now be described.

Specifically, the object determination unit 405 calculates the ratio p of the number of the distance values D(Bj) similar to the distance value D(As) of the target point with respect to the number of the distance values D(Bj) of the respective surrounding points and calculates the error e of the ratio p. If the error e is not higher than the certain value, the object determination unit 405 determines that the sufficient surrounding points are set and determines whether any object exists based on the ratio p. If the error e is higher than the certain value, the object determination unit 405 determines that the number of the surrounding points that are set is not sufficient. In this case, the process goes back to the step in the surrounding point setting unit 403 and the number N of the surrounding points is increased. The above steps are repeated until the error e is made not higher than the certain value. This enables the increase in the calculation time to be suppressed while ensuring that the error e is not higher than the certain value.

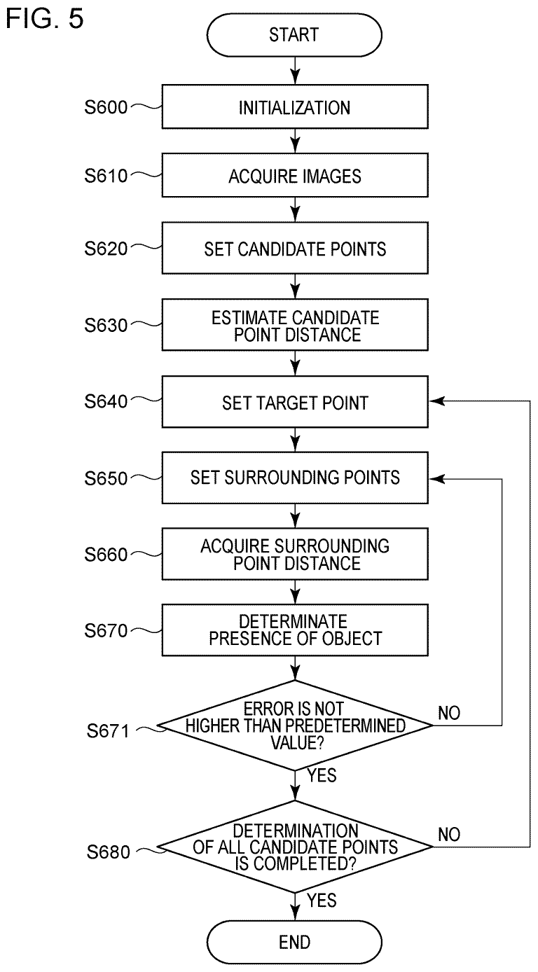

A specific process of a first modification will now be described. FIG. 5 is a flowchart illustrating the process. The process in FIG. 5 differs from the process in FIG. 4 in Step S650 performed by the surrounding point setting unit 403 and Step S670 and Step S671 performed by the object determination unit 405. The process will be described in detail below.

In Step S650, the surrounding point setting unit 403 sets multiple points around the target point As. In the first modification, the surrounding point setting unit 403 selects the points of the number N at random from the pixels existing in the range of the radius R around the target point As and sets the selected points as the surrounding points. The surrounding points that are set is denoted by Bj(j=1 to N).

If the object determination unit 405 determines that the error e is higher than the certain value, the number N is increased by an x number. In the first modification, x is set to one (1) and the number N is incremented by one.

In Step S670, the object determination unit 405 determines whether the target point is noise based on the distance values of the target point and the surrounding points to determine whether any object exists in the detection space 110.

First, the ratio p of the number of the distance values D(Bj) similar to the distance value D(As) of the target point with respect to the number of the distance values D(Bj) of the respective surrounding points is calculated. Specifically, the ratio of the number of the surrounding points having the distance values within a predetermined range from the distance value D(As) of the target point with respect to the number N of the set surrounding points is calculated. In addition, the error e of the ratio p is calculated. The error e of the ratio p is calculated according to Equation (1):

$$\begin{matrix}[ Formula 1 ] & \\ e = k \sqrt{\frac{p \text{?} ( 1 - p )}{N}} & ( 1 )\end{matrix}$$

$$\text{?} \text{indicates text missing or illegible when filed}$$

In Equation (1), k is a coefficient for adjusting the degree of the error and k=1 in the first modification. The method of calculating the error e for data that is sampled, indicated in Equation (1), is known and is explained in, for example, H. Taherdoost, “Determining Sample Size; How to Calculate Survey Sample Size”, Mathematics Leadership & Organizational Behavior eJournal, 2017.

In Step S671, the object determination unit 405 determines whether the error e is not higher than a threshold value U. If the error e is not higher than the threshold value U (YES in Step S671), the object determination unit 405 determines whether any object exists based on the ratio p, as in the flowchart in FIG. 4. Then, the process goes to Step S680. If the error e is higher than the threshold value U (NO in Step S671), the object determination unit 405 determines that the number N of the surrounding points set in the surrounding point setting unit 403 is not sufficient. In this case, the process goes back to Step S650 performed by the surrounding point setting unit 403. The surrounding point setting unit 403 increases the number of the surrounding points to N+x to decrease the error e when the ratio p is calculated again.

As described above, the number of the surrounding points set in the surrounding point setting unit 403 is adjusted based on the distribution of the distance values of the surrounding points. Since an excessive increase of the number of the surrounding points for decreasing the error is avoided, it is possible to reduce the calculation cost.

The object determination unit 405 in the first modification calculates the error e based on Equation (1). The error e supposed for the ratio p may be calculated using another method. For example, the error may be calculated with reference to a table of the values of the error e with respect to the ratio p and the number N, which is created in advance. The table is created by, for example, generating the range image using the stereo images under various conditions as inputs, calculating the ratio p from the distribution of the distance values of the surrounding points with the target point being set at various portions, and recording the error e of the ratio p. In this case, the true value of the ratio p of each target point is calculated using all the points around the target point.

The surrounding point setting unit 403 in the first modification sets x=1 and increments the number N of the surrounding points by one. However, x may be one or may be a number greater than one. For example, when the error e is large, it is efficient to increment the number N of the surrounding points by a plural number rather than the increment of the number N of the surrounding points by one. Accordingly, x may be determined so that x is increased as the error e is increased.

Also in the increase in the number of the surrounding points in the surrounding point setting unit 403, the distribution of the positions of the surrounding points desirably has no bias. Accordingly, the number of the surrounding points may be preferentially increased at positions having low densities in the distribution of the surrounding points that have been set.

### Second Modification

Whether any object exists is detected at multiple portions by repeating the selection of the target point in Step S580. In a second modification, it is determined that any object exists at a time when one point within the detection space has been detected.

In the second modification, if the object determination unit 405 determines that any object exists in the detection space 110, the calculation for the candidate points to be subsequently set as the target point is skipped. This enables unnecessary calculation cost to be reduced.

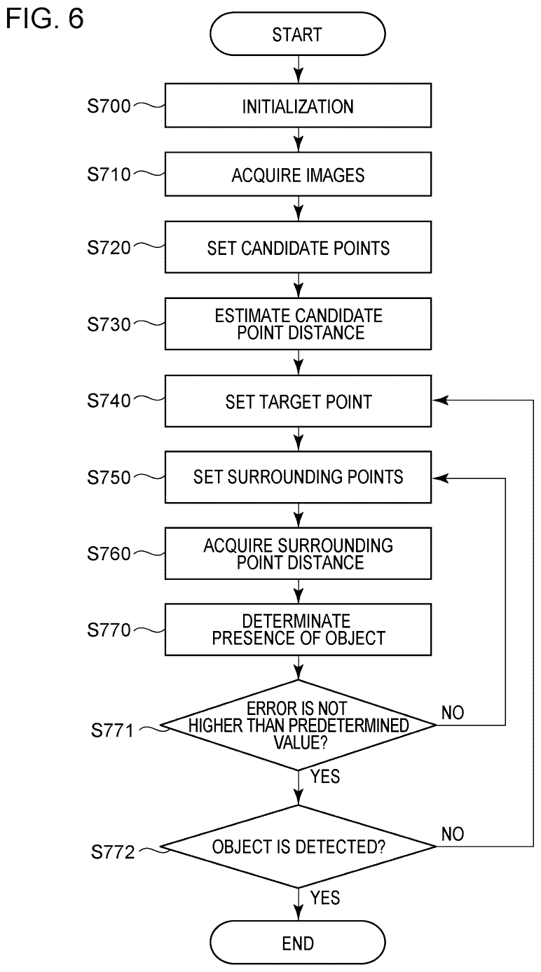

A specific process of the second modification will now be described. FIG. 6 is a flowchart illustrating the process. The process in FIG. 6 differs from the processes in FIG. 4 and FIG. 5 in Step S772 performed by the object determination unit 405. The process will be described in detail below.

In Step S772, the object determination unit 405 determines whether any object is detected. If the object determination unit 405 determines that no object exists (NO in Step S772), the process goes back to Step S740 performed by the target point setting unit 402 to set the subsequent target point. If the object determination unit 405 determines that any object exists (YES in Step S772), the determination of the subsequent candidate points is skipped and the process in FIG. 6 is terminated.

As described above, if the object determination unit 405 determines that any object exists, the determination of the subsequent candidate points is skipped to reduce the calculation cost.

### Third Modification

In a third modification, the target point setting unit 402 sequentially sets the candidate point having a lower distance value as the target point. This enables the object closer to the stereo camera to be preferentially detected while reducing the calculation cost.

A specific process of the third modification will now be described. FIG. 6 is a flowchart illustrating the process. The process in FIG. 6 differs from the processes described above with reference to the above flowcharts in Step S740 performed by the target point setting unit 402. The process will be described in detail below.

In Step S740, the target point setting unit 402 sets the point existing in the detection space 110, among the candidate points, as the target point. At this time, the candidate points are sorted in advance based on their distance values and the candidate point having a lower distance value to the stereo camera is sequentially set as the target point. Since the sorting based on the distance values of the candidate points is performed, it is not necessary to set the target point in the order of the distance values. Preferentially setting the target point having a lower distance value enables the object closer to the stereo camera to be preferentially detected while reducing the calculation cost.

Accordingly, the object determination unit 405 determines whether the target point having a lower distance value is on the object. If the object determination unit 405 determines that the object exists (YES in Step S772), the determination for the subsequent candidate points is skipped and the process in FIG. 6 is terminated.

As described above, since sequentially setting the candidate point having a lower distance value from the stereo camera as the target point enables the processing of the remaining candidate points to be skipped while ensuring that the object closer to the stereo camera is preferentially detected, it possible to reduce the calculation cost.

The target point setting unit 402 in the third modification sets the target point based on the distance value.

Alternatively, for example, attention may be given to an object existing in a central portion of the image and the target point may be set based on the distance from the central portion of the image to each candidate point. If it is determined that the object exists in the central portion of the image, the subsequent determination may be skipped.

### Fourth Modification

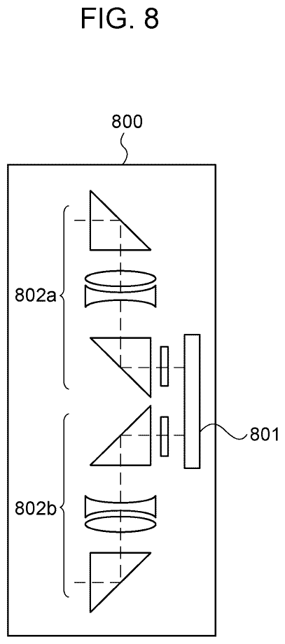

The image acquisition unit 401 can adopt the method of acquiring two images captured at different points of view. For example, the method of acquiring the images captured by the stereo camera, which is described in the embodiment, the method of acquiring images captured at two points of view while one camera is being moved, and so on can be adopted. Alternatively, an imaging apparatus 800 illustrated in FIG. 8 may be used as an exemplary imaging apparatus that includes two optical systems and two optical paths. The imaging apparatus 800 forms an image from light beams from multiple imaging optical systems (802a and 802b) using one imaging device 801 (a complementary metal oxide semiconductor (CMOS) sensor or a charge-coupled device (CCD) sensor). The imaging apparatus 800 records light beams input from the respective twin lenses with the one CMOS sensor. The image acquisition unit 401 may acquire the image captured by the imaging apparatus 800.

The present disclosure is capable of being realized by the following process. Specifically, software (programs) realizing the functions in the embodiment described above is supplied to a system or an apparatus via a network or various storage media and the programs are read out and executed by the computer (or a central processing unit (CPU), a micro processing unit (MPU), or the like) in the system or the apparatus. The programs may be recorded and supplied on a computer-readable recording medium.

According to the present disclosure, it is possible to accurately determine whether a feature point indicating a feature of an object is acquired from the three-dimensional space in a moving direction of a vehicle while suppressing the processing load.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A moving device control apparatus comprising:
one or more processors; and
at least one memory storing executable instructions, which when executed by the one or more processors, cause a moving device to perform a method comprising:
acquiring a first image from a first optical system and a second image from a second optical system, the first image and the second image being acquired from an imaging apparatus that includes the first optical system and the second optical system, which are arranged in a device so that an imaging field of view of the first optical system is at least partially overlapped with an imaging field of view of the second optical system;
performing a first stereo matching on the first and second images for a first number of feature points smaller than a number of pixels in the first image to estimate three-dimensional positions of the feature points with respect to the imaging apparatus;
setting selectively a feature point having an estimated three-dimensional position within a three-dimensional space, defined in a moving direction of the moving device, in which an object to be detected is located, among the feature points of the first number, as a target point;
setting surrounding points of a second number that a density of the surrounding points is higher than the feature points for which the three-dimensional positions are estimated in an image region between the target point and the feature points estimated;
estimating, using a second stereo matching, three-dimensional positions of the set surrounding points, wherein the three-dimensional positions of the set surrounding points have not been estimated by the first stereo matching; and
determining the target point is the feature point indicating a feature of an object existing in the three-dimensional space in a case where, based on a number of surrounding points for which a distance from a predetermined position of the imaging apparatus to an estimated three-dimensional position of each surrounding point is similar to a distance from the predetermined position of the imaging apparatus to the three-dimensional position of the target point, the number exceeds a threshold, and determining that the target point is noise in a case where the number of surrounding points is equal to or less than the threshold.

2. The moving device control apparatus according to claim 1,
wherein the determining determines whether the target point is the feature point indicating a feature of an object existing in the three-dimensional space based on a number of the surrounding points having the values of distances from the imaging apparatus to positions indicated by the surrounding points, which are similar to the value of a distance from the imaging apparatus to a position indicated by the target point, or a ratio of the number of the surrounding points having the values of the distances from the imaging apparatus to the positions indicated by the surrounding points, which are similar to the value of the distance from the imaging apparatus to the position indicated by the target point, with respect to the number of the surrounding points.

3. The moving device control apparatus according to claim 1,
wherein, if an error of a number of the surrounding points having the values of distances from the imaging apparatus to positions indicated by the surrounding points, which are similar to the value of a distance from the imaging apparatus to a position indicated by the target point, or an error of a ratio of the number of the surrounding points having the values of the distances from the imaging apparatus to the positions indicated by the surrounding points, which are similar to the value of the distance from the imaging apparatus to the position indicated by the target point, with respect to the number of the surrounding points exceeds a predetermined value, the setting the surrounding points increases the surrounding points that serve as the population for calculating the number or ratio of points with similar distances.

4. The moving device control apparatus according to claim 1,
wherein the setting the surrounding points sets the surrounding points in the first image such that the surrounding points are set within a predetermined spacing around the target point.

5. The moving device control apparatus according to claim 1,
wherein the setting selectively the feature point preferentially sets the feature point having a shorter distance from the imaging apparatus, rather than at the feature point having a longer distance from the imaging apparatus, to a position indicated by the feature point as the target point.

6. The moving device control apparatus according to claim 1,
wherein the setting selectively the feature point preferentially sets the feature point having a shorter two-dimensional distance excluding depth information from a center of the first image as the target point than the feature point having a longer two-dimensional distance.

7. A method for controlling a moving device, the method comprising:
acquiring a first image from a first optical system and a second image from a second optical system, the first image and the second image being acquired from an imaging apparatus that includes the first optical system and the second optical system, which are arranged in a device so that an imaging field of view of the first optical system is at least partially overlapped with an imaging field of view of the second optical system;
performing a first stereo matching on the first and second images for a first number of feature points smaller than a number of pixels in the first image to estimate three-dimensional positions of the feature points with respect to the imaging apparatus;
setting selectively a feature point having an estimated three-dimensional position within a three-dimensional space, defined in a moving direction of the moving device, in which an object to be detected is located, among the feature points of the first number, as a target point;
setting surrounding points of a second number that a density of the surrounding points is higher than the feature points for which the three-dimensional positions are estimated in an image region between the target point and the feature points estimated;
estimating, using a second stereo matching, three-dimensional positions of the set surrounding points, wherein the three-dimensional positions of the set surrounding points have not been estimated by the first stereo matching; and
determining the target point is the feature point indicating a feature of an object existing in the three-dimensional space in a case where, based on a number of surrounding points for which a distance from a predetermined position of the imaging apparatus to an estimated three-dimensional position of each surrounding point is similar to a distance from the predetermined position of the imaging apparatus to the three-dimensional position of the target point, the number exceeds a threshold, and determining that the target point is noise in a case where the number of surrounding points is equal to or less than the threshold.

8. A non-transitory computer-readable medium storing one or more programs including instructions, which when executed by one or more processors of a moving device control apparatus, cause the moving device to perform the information processing method according to claim 7.
